(19) United States
(12) Patent Application Publication
(10) Pub. No.: US 2024/0024890 A1
(43) Pub. Date: Jan. 25, 2024

(54) ROCK PROCESSING APPARATUS WITH IMPROVED PLANNING FOR REDUCING THE STOCKPILE OF THE PROCESSING OUTPUT

(71) Applicant: Kleemann GmbH, Goppingen (DE)

(72) Inventors: Tobias Böckle, Weinstadt (DE); Thomas Kühnle, Kirchheim / Teck (DE)

(21) Appl. No.: 18/353,357

(22) Filed: Jul. 17, 2023

(30) Foreign Application Priority Data
Jul. 19, 2022 (DE) 10 2022 118 039.5

(51) Int. Cl. B02C 23/14; B02C 23/12; B02C 11/04; B02C 13/06; B02C 13/286; B02C 25/00

(52) U.S. Cl. CPC B02C 23/14; B02C 23/12; B02C 11/04; B02C 13/06; B02C 13/286; B02C 25/00; B02C 9/04

(57) ABSTRACT

The present disclosure relates to a rock processing apparatus (12) for crushing and/or sorting granular mineral material (M) according to size, comprising:
a material feeding apparatus (22) including a material buffer (24),
at least one working unit of: at least one crushing apparatus (14) and at least one screening apparatus (16, 18),
at least one conveyor apparatus (26, 32) for conveying material between two apparatus components,
at least one discharge conveyor apparatus (29, 42, 46) for conveying processed material onto a stockpile (30, 44, 48),
a control unit (60),
at least one stockpile sensor (96, 98) for detecting at least one state and/or a change over time of a size of the stockpile (30, 44, 48), the stockpile sensor (96, 98) being connected to the control unit (60),
at least one output device (66) for outputting information, the output device (66) being connected to the control unit (60).

The control unit (60) is designed to ascertain, in an operation with a discontinuous reduction of the at least one stockpile (30, 44, 48), on the basis of the at least one detection signal, a piece of reduction time information about an execution time of a future reduction of the stockpile (30, 44, 48), wherein the output device (66) is designed to output the ascertained reduction time information.

### CROSS-REFERENCES TO RELATED APPLICATIONS

This application claims benefit of German Patent Application No. 10 2022 118 039.5, filed Jul. 19, 2022, and which is hereby incorporated by reference.

### BACKGROUND

The invention relates to a rock processing apparatus for crushing and/or sorting granular mineral material according to size.

In the related art, WO 2020/007846 A1 discloses a method and a device for managing bulk material of a mine. The printed publication is focused considerably on the conveyor apparatus building up the stockpile that is to be reduced. There must necessarily be an apparatus located upstream of the conveyor apparatus, which crushes material from the mine into granular bulk material, which is eventually conveyed to the stockpile by the conveyor apparatus. The method and device known from WO 2020/007846 A1 essentially serve locally to register, when building up a stockpile, areas of heaped bulk material having identical material parameters within an area, but having different material parameters, such as ore content for example, between areas, in order to allow for their targeted removal when reducing the stockpile.

The present disclosure further relates to a mobile rock processing apparatus, not disclosed in WO 2020/007846 A1, having a travel gear, which allows the rock processing apparatus to change its place of installation in self-propelled fashion and/or to move in self-propelled fashion between a place of installation for a rock processing operation and a transport means for transporting the rock processing apparatus. Because of the normally high weight of the mobile, in particular self-propelled, rock processing apparatus, the travel gear is usually a crawler travel gear, although a wheel travel gear is not to be ruled out as an alternative or addition to a crawler travel gear.

A rock processing apparatus having both a screening apparatus as well as a crushing apparatus is known from U.S. Pat. No. 4,281,800. This previously known rock processing apparatus is part of a rock processing system having a rock grinding mill situated downstream from the rock processing apparatus in the flow of material. From a quarry, the rock processing apparatus is continuously loaded by a conveyor belt with material to be processed.

U.S. Pat. No. 4,909,449 discloses a rock processing apparatus, which indicates via a light system, for example a kind of traffic light system, to vehicles that load the rock processing apparatus in discontinuous fashion, whether the rock processing apparatus is at the moment ready to be fed newly supplied rock.

For a technically and economically optimized operation, it is helpful that a stockpile built up by a discharge conveyor apparatus is reduced in timely fashion, before it grows to such an extent that its growth impairs or influences the operation of the discharge conveyor apparatus. For an economically optimized operation, it is also helpful not to reduce a stockpile built up by a discharge conveyor apparatus too much, depending on external conditions, so as not to imperil its stability. In particular in conditions of strong wind, material discharged onto a stockpile that has been reduced too much may be blown away in undesired fashion due to the long duration of the fall, resulting in the loss of material processed by the rock processing apparatus.

### SUMMARY

An object of the present disclosure is therefore to improve the rock processing apparatus on the discharge side for discharging processed material for a technical and economical operation that is as advantageous as possible.

A rock processing apparatus as disclosed herein may achieve this object in that the control unit is designed to ascertain, in an operation with a discontinuous reduction of the at least one stockpile, a piece of reduction time information on the basis of the at least one detection signal, which represents an execution time of a future reduction of the stockpile by removing material from the stockpile, wherein the output device is designed to output the ascertained reduction time information.

The detection signal of the stockpile sensor may represent a state of the stockpile, in particular a state of the size and/or the shape of the stockpile. The size of the stockpile may be represented by its height above the ground that supports it or by parameter values from which this height can be inferred. By detecting a state of the shape of the stockpile, it is also possible to infer its size, for example, in the case of a conical stockpile, by knowing the diameter of its base resting on the ground that supports it and the inclination of its lateral surface relative to the ground or of the angle of the cone.

Thus, the at least one stockpile sensor can detect at least one shape dimension of the stockpile as the at least one stockpile parameter. Possible shape dimensions are the previously mentioned parameters: height of the stockpile, diameter or generally a characteristic dimension of the stockpile base and/or surface area of the stockpile base, angle of inclination of the lateral surface of the stockpile extending from the stockpile base to a stockpile top situated at the remote end of the stockpile in the vertical direction. The control unit is then designed to ascertain a height of a stockpile top on the basis of the at least one detected shape dimension.

The rock processing apparatus preferably comprises a time measuring device, which is connected in signal-transmitting fashion to the control unit, possibly by interposition of a data memory. The or a time measuring device may be integrated in the at least one sensor and/or in the input device and/or in the control unit. Via signals of the time measuring device, the control unit is able to assign an event time to detection events of the at least one stockpile sensor and/or detection events of at least one operation sensor for detecting at least one operating parameter of the rock processing apparatus and/or input events of at least one input device. From the time interval of at least two event times for an event of the same kind, for example the detection of one and the same stockpile parameter or one and the same operating parameter, the control unit is able to determine a rate of change associated with the respective events. Thus, from two detections of the stockpile height or generally of a state of the stockpile size and/or of the stockpile shape and the known time interval between these detection events, the control unit is able to ascertain a rate of change of the stockpile size and/or of the stockpile shape. This is an example of an ascertainment of a change over time of the height of the stockpile top of the stockpile as a growth parameter of the stockpile.

From the ascertained growth parameter and a state of the stockpile size and/or of the stockpile shape known through detection, the control unit is able to ascertain, for example by extrapolation, a next execution time of a material removal, possibly by taking into consideration a safety margin which is to ensure that the stockpile does to reach a predetermined location. The predetermined location may be a discharge area of the discharge conveyor apparatus building up the respective stockpile so as to prevent the stockpile from growing up to the discharge conveyor apparatus and colliding with the latter and/or blocking the latter. Additionally or alternatively, the predetermined location may be the spatial area of a neighboring stockpile so as to prevent its material from mixing with the material of the currently stacked stockpile.

In addition to the state of the size and/or of the shape of the stockpile, a fill ratio of the discharge conveyor apparatus building up the respective stockpile may be detected by at least one operation sensor as a relevant operating parameter of the rock processing apparatus. For the conveying capacity of the discharge conveyor apparatus influences the stockpile growth directly. By detecting the fill ratio of the discharge conveyor apparatus stacking the respective stockpile, the control unit is able to check the at least one ascertained stockpile parameter for plausibility or even correct it. The same applies to the detection of a conveying speed of the discharge conveyor apparatus, which builds up the respective stockpile by its conveying operation.

The product of fill ratio and conveying speed of a conveyor apparatus provides a measure for the material volume conveyed by the conveyor apparatus or for the conveying capacity of the conveyor apparatus.

The conveyor apparatus as well as the discharge conveyor apparatus may be in each instance a belt conveyor apparatus or a trough conveyor apparatus, the latter conveying preferably according to the micro throw principle as a vibrating conveyor. A vibrating conveyor, preferably in the form of a trough conveyor apparatus, is preferred especially as a conveyor apparatus for conveying material between the material buffer and a crushing apparatus. The rock processing apparatus may also comprise a plurality of conveyor apparatuses and will normally comprise such a plurality, for example because one and the same conveyor apparatus is not able to convey material as a feed conveyor apparatus from the material buffer to a working unit and as a discharge conveyor apparatus away from a working unit and out of the rock processing apparatus onto a stockpile built up thereby. In the case of a plurality of conveyor apparatuses, these may use different conveying principles, such as the micro throw principle in vibrating conveyors already described above and/or such as a belt conveyor, the belt conveyor being normally used as a discharge conveyor apparatus due to the smaller grain size occurring in the discharge and a usually more homogeneous grain size distribution.

A conveying speed of a conveyor apparatus may be ascertained in various ways. The conveying speed may be determined independently of the type of conveyor apparatus by detecting a motion in the conveying direction of a material lying on the conveyor apparatus, for example by a light barrier, by ultrasound, by optical detection and image processing and the like. A conveying speed of a belt conveyor may be detected by detecting the speed of a pulley cooperating with the conveyor belt, be it a support pulley or a drive pulley, or by directly detecting the track speed of the conveyor belt. In vibrating conveyors, the vibration amplitude and vibration frequency may be a measure for the speed of material supported on a vibrating conveyor, so that a detection of the vibration amplitude and of the vibration frequency is a detection of values of variables representing the conveying speed. For all conveyor apparatuses, it is also the case that their conveying capacity is derivable from the drive power of a motor that drives them, so that the conveying capacity can be derived indirectly from the detection of a motor torque and of a motor speed. For some types of electric motors, the output motor torque may be ascertained from the motor current drawn. For hydraulic motors, the output torque is proportional to the product of the pressure drop across the hydraulic motor and its displacement. Otherwise, it is possible to ascertain a torque characteristic map for each motor as a function of its control variables and to store it in a data memory or in the data memory already mentioned above. From the detected control variables, the control unit is then able to ascertain the motor torque by retrieving the torque characteristic map.

Since the detection signal, as described at the outset, represents at least one stockpile parameter detected by a sensor, the control unit is able to ascertain on the basis of the at least one detection signal a future requirement of the rock processing apparatus to reduce or remove processed material discharged onto the at least one stockpile and thus to predict it as reduction time information. The terms “reduction” and “removal” are used synonymously in the present application. By outputting the ascertained reduction time information, third parties, such as for example a machine operator of a removal apparatus, are able to note the reduction time information and consequently plan their material reduction at the at least one stockpile formed by the rock processing apparatus in advance. Alternatively, the ascertained and output reduction time information may be processed in automated fashion by a data processing device, such as a control unit for example, of at least one removal apparatus and the reduction operation of the latter may be set up and executed by considering the reduction time information, so that at the execution time represented by the reduction time information a material reduction may in fact be performed at the at least one stockpile.

In principle, the rock processing apparatus may comprise more than one discharge conveyor apparatus, each of which building up a stockpile during the normal operation of the rock processing apparatus. A discharge conveyor apparatus may also be situated so as to be movable relative to a machine frame of the rock processing apparatus, so that one and the same discharge conveyor apparatus may successively build up more than one stockpile. This also applies to a discharge conveyor apparatus of a plurality of discharge conveyor apparatuses of the rock processing apparatus.

The execution time may be an execution point in time and/or an execution period of time. The execution time may indicate the earliest possible future time, at which or starting at which material may be or should be removed at the at least one stockpile. The execution time may additionally or alternatively indicate a future time span, over which material may be or should be reduced or removed at the at least one stockpile.

The reduction time information may be a relative reduction time information with respect to a reference time, for example the current actual time. The reduction time information may be output for example as a waiting time until the next material reduction. Alternatively, the reduction time information may be an absolute reduction time information, which represents an execution time or a beginning of an execution time span as a time of day in the respective relevant time zone. If required, an end of the execution time span may again refer as absolute reduction time information or as relative reduction time information to a reference time, preferably to the beginning of the execution time span. Normally, it will suffice, however, to indicate as the execution time the point in time starting at which a material reduction may be performed in the future.

At the time at which the reduction time information is output by the output device, the execution time represented by the reduction time information lies in the future. This concerns not only a theoretical future on the basis of signal transmission durations in the microsecond or nanosecond range, but a future, which is in the single-digit second range from the time of the output of the reduction time information. Often, the execution time will be in the double-digit or even triple-digit or quadruple-digit second range in the future from the time of the output of the reduction time information.

In the operation with a discontinuous reduction of the at least one stockpile, the rock processing apparatus is preferably designed to ascertain respectively an individual execution time as reduction time information for at least two, particularly preferably for more than two consecutive future material removals and to output these respectively via the output device. Thus, the execution times of a series of consecutive material removals may be suitably ascertained and output as reduction time information as a function of the at least one stockpile parameter represented by the at least one detection signal and/or by a sensorially detected operating parameter of the rock processing apparatus, that is, ascertained and output individually for the operating situation of the reduced stockpile that continues to be built up by its associated discharge conveyor apparatus, as this operating situation develops further due to the preceding material reduction.

The rock processing apparatus may comprise only one or multiple screening apparatuses as the at least one working unit. The rock processing apparatus is then a pure screening system. In the same way, the rock processing apparatus may comprise only one or multiple crushing apparatuses as the at least one working unit. The rock processing apparatus is then a pure crushing system. In the preferred configuration, the rock processing apparatus comprises both at least one screening apparatus as well as at least one crushing apparatus. The screening apparatus may be a pre-screen situated upstream of the crushing apparatus in the flow of material, possibly having multiple screen decks, and/or it may be a post-screen situated downstream from the crushing apparatus in the flow of material in order to sort the output provided by the crushing apparatus according to grain sizes. The post-screen may also comprise at least one screen deck or multiple screen decks.

The crushing apparatus may be any known crushing apparatus, for example an impact crusher or a jaw crusher or a cone crusher or a roll crusher. If the rock processing system has more than one crushing apparatus, these crushing apparatuses may be crushing apparatuses of the same kind or of different kinds. Each individual crushing apparatus may be one of the aforementioned crusher types: impact crusher, jaw crusher, cone crusher and roll crusher.

To ascertain the reduction time information, the control unit may be designed to retrieve a lower height threshold value of the stockpile from a data memory and to ascertain, starting from the growth parameter, a piece of reduction time information for an earliest future reduction of the stockpile.

The lower height threshold value or a further lower height threshold value may also be used by the control unit in order to ascertain a maximum reduction quantity of material removable from the stockpile so as to ensure a minimum size of the stockpile remaining after the material reduction.

Additionally or alternatively, the control unit may be designed to retrieve an upper height threshold value of the stockpile from a data memory and to ascertain, starting from the growth parameter, a piece of reduction time information for a latest future reduction of the stockpile.

The data memory is preferably the data memory already mentioned above. Quite generally, the rock processing apparatus preferably comprises a data memory, which is connected to the control unit in signal-transmitting fashion and is preferably also connected to the at least one stockpile sensor.

Although it is in principle possible that the control unit ascertains the reduction time information exclusively from detection signals of the at least one stockpile sensor, possibly with the consideration of detection signals of at least one operation sensor for ascertaining at least one operating parameter of the rock processing apparatus, it is not to be ruled out that the control unit also takes into consideration information input by a machine operator or another person when ascertaining the reduction time information. For this purpose, a preferred development of the present disclosure may provide for the rock processing apparatus to comprise an input device for inputting information, the input device being connected in signal-transmitting fashion to the control unit for transmitting information, the control unit being designed, in the operation with a discontinuous stockpile reduction, to ascertain the reduction time information on the basis of the at least one detection signal and a piece of information input into the input device.

The input device may be any input device, such as a keyboard, a touchscreen and the like. The input device may also be connected to the control unit in signal-transmitting fashion via a cable link or a radio link, so that it is not necessary for it to be physically present on the rock processing apparatus. A signal-transmitting connection of the input device or even of the at least one stockpile sensor and/or of the at least one operation sensor to the control unit may also be a connection by interposition of the data memory, in which pieces of information input into the input device and/or pieces of information output by the at least one stockpile sensor for detecting the at least one stockpile parameter and/or by the at least one operation sensor are stored as data and are retrieved as stored data by the control unit. In the same way, the input apparatus and/or the at least one stockpile sensor and/or the at least one operation sensor may be connected directly to the data memory in signal-transmitting fashion, so that the input device is able to transmit the information input into it just as directly into the data memory for storage as the at least one stockpile sensor and/or the at least one operation sensor is able to transmit outputs of the respective detection operation of the sensor.

Data, which do not change over the operational life of the rock processing device or which can be changed only with great effort, for example via the structural configuration of the rock processing apparatus and its components, may be stored permanently in the data memory and may be stored for example by the manufacturer of the rock processing apparatus during the manufacture of the same or prior to its delivery. Nevertheless, if the machine configuration should change, for example in the course of maintenance or repair, the service provider performing the maintenance or repair work is able to make appropriate changes to the content of the data memory.

The data memory may be connected to the control unit in signal-transmitting fashion by a physical signal line and/or wirelessly, for example by a radio link or by a transmission of optical signals. In principle, the data memory may therefore be provided separately and at a distance from the rest of the rock processing apparatus. The “rest of the rock processing apparatus” is here represented by its machine body. The machine body comprises the machine frame and all components of the rock processing apparatus connected to the machine frame, even when these are connected so as to be movable relative to the machine frame.

The stockpile sensor may be situated in various ways in relation to the rest of the rock processing apparatus. According to a preferred specific embodiment, for example, the at least one stockpile sensor may be situated as an apparatus-supported stockpile sensor on the rock processing apparatus. Since the discharge conveyor apparatus, which heaps up the stockpile detected by the stockpile sensor, is spatially located particularly near the stockpile to be detected by sensor, the discharge conveyor apparatus is a possible preferred location for situating the stockpile sensor. The discharge conveyor apparatus is often a belt conveyor apparatus, which throws off processed material, so that, taking into account a lateral distance due to the trajectory of the thrown-off material in the shape of a ballistic parabola, a stockpile grows upward over time under the longitudinal discharge end of the discharge conveyor apparatus. A longitudinal end area of the discharge conveyor apparatus comprising the longitudinal discharge end is in that case a preferred location for situating the stockpile sensor. The longitudinal end area preferably comprises the final 20%, particularly preferably the final 10% of the conveyor length of the discharge conveyor apparatus including the longitudinal discharge end.

Additionally or alternatively, the at least one stockpile sensor may be secured in position in the surroundings of the rock processing apparatus as a stationary, ground-supported stockpile sensor at a spatial distance from the rock processing apparatus, but connected to the latter in signal-transmitting fashion. For example, the at least one stockpile sensor may be set up or anchored on the ground by its own stand or framework, so that it is able to detect the stockpile to be monitored by it particularly well, but due to a spatial distance remains largely unimpaired by dirt or flying bulk material.

Additionally or alternatively, the at least one stockpile sensor may be provided as a mobile stockpile sensor movable relative to the rock processing apparatus, but connected to the latter in signal-transmitting fashion. The stockpile sensor may be situated on another vehicle of the job site, on which the rock processing apparatus is deployed. The stockpile sensor may also be situated on an aerial drone, which flies over and/or flies around the stockpile to be detected by the stockpile sensor, in particular flying over and/or flying around the stockpile in a predetermined pattern, so that information about the stockpile may be detected indeed at different times, but preferably from the same detection locations, which increases the comparability of information about the stockpile detected at different times. For this purpose, the control unit of the rock processing apparatus may preferably be designed to let an aerial drone carrying at least one stockpile sensor fly a predetermined trajectory in a remote-controlled manner according to a predetermined program. The predetermined trajectory may be established in advance by a teach-in method and stored in the data memory. In place of an aerial drone, at least one stockpile sensor may be situated on a land-based remote controlled vehicle, which is less preferred, however, on account of the higher risk of damage due to the rough operating conditions on a typical job site. The term “job site” very generally includes any location of a production or provision of material to be processed by the rock processing apparatus, such as stone quarries, gravel pits, recycling yards, building demolition sites and the like. The term “mineral material” therefore includes both natural mineral material as well as mineral material produced by processing. The latter includes building materials as well as returned oversize grain.

The at least one stockpile sensor may detect the at least one stockpile parameter on the basis of different physical operating principles. For example, the at least one stockpile sensor may detect the at least one stockpile parameter acoustically, in particular by ultrasonics. Thus, from the propagation time of ultrasound reflected by the stockpile, in particular by the top of the stockpile, it is possible to determine a distance of the stockpile, in particular of the top of the stockpile. From the known position of the stockpile sensor relative to the machine frame of the rock processing apparatus and the known geometry of the machine frame, it is possible to obtain the position of the stockpile sensor relative to the ground surrounding the rock processing apparatus and thus information about the height of the top of the stockpile may be obtained from the detection signal.

Alternatively or additionally, the stockpile sensor may detect the stockpile and in particular the top of the stockpile by electromagnetic radiation. For this purpose, in an analogous manner to the ultrasound-based detection described above, propagation time measurements of reflected electromagnetic beams allow for the ascertainment of a distance of the irradiated stockpile area from the stockpile sensor and from this information allows for the ascertainment of information about the height of the irradiated stockpile area by taking into consideration the known position of the stockpile sensor, a known direction of beam and known machine dimensions.

A detection of the at least one stockpile parameter using electromagnetic radiation also includes the utilization of passive electromagnetic radiation, for example light, which is reflected by the stockpile. Such an optical detection of the stockpile, for example by a camera, including image processing of the optical detection outputs makes it possible to ascertain information about the height of a top of the stockpile and/or, if there is sufficient contrast between the stockpile and its background, shape information, for example with respect to an angle of the cone of a normally heaped conical stockpile.

Additionally or alternatively, height information and/or shape information of the stockpile may be detected in a tactile manner in that, starting from a known location of the stockpile sensor, a tactile element known in its spatial position relative to the stockpile sensor is brought into contact with a surface of the stockpile. With repeated contact of the tactile element, it is thus possible to ascertain points of the stockpile surface and extrapolate from these a stockpile shape.

According to an advantageous development of the present disclosure, the output device may be designed to output, in addition to the reduction time information, information about the type and/or the composition and/or the location of the stockpile material.

Information about the type of the stockpile material may have been previously input via the input device or may have been transmitted from another device on the job site to the rock processing apparatus. Furthermore, information about the type of the stockpile material may have been ascertained at the rock processing apparatus itself. Information about the type of the stockpile material includes information about the average grain size, the grain size distribution, the grain shape, the moisture content, the abrasiveness, the crushing behavior of the material or also the color of the material. Something analogous applies to the ascertainment and provision of information about the composition of the material. The latter may be ascertained for example on the job site by a separate device or by corresponding sensors on the rock processing apparatus by irradiation with high-energy electromagnetic beams, such as X-rays, from the irradiation response of the irradiated material with the aid of characteristic maps stored in the data memory.

The location of the stockpile material may be ascertained and output from the known location of the rock processing apparatus, known for example via GPS receivers of the rock processing apparatus, and the location of the stockpile known relative to the rock processing apparatus via the at least one stockpile sensor. The output device may output the location of the stockpile to be reduced in GPS coordinates and/or in coordinates relative to a reference point of the rock processing apparatus and/or the job site. A removal apparatus may thereby receive information not only regarding the time starting at which it is to reduce material, and possibly how much material, but also where this is to occur. If multiple stockpiles are heaped on a job site, this significantly facilitates the orientation of the removal apparatus and the targeted reduction.

In order to make the reduction time information accessible to third parties, in particular machine operators of removal apparatuses, the output device may be designed to output information in a kind of undirected output independently of the receiver into a spatial region at least partially surrounding the rock processing apparatus and/or adjoining the rock processing apparatus. This preferably means that no receiving device is required in order to present the reduction time information output by the output device in a form that is comprehensible for human beings or for electronic data processing devices.

The output device may thus output the reduction time information in a visually perceptible manner, for example by displaying a time of day, which indicates the calculated earliest possible reduction time for the next material reduction. Instead of an absolute time of day, it is possible to display the remaining waiting time until the next reduction time. This may be done in digital or analog, graphical or numerical fashion. For example, the waiting time until the next reduction time may be displayed numerically by a digital clock with a unit of time countdown, for example by seconds or by seconds and minutes. The waiting time may also be displayed graphically-numerically by an analog clock or by an analog indicator instrument, for example again with a unit of time countdown by a corresponding continuous or stepped indicator movement. A purely graphical representation of the waiting time, for example as a waiting time graph dimensionally proportional to the remaining waiting time, such as a waiting time bar proportional in length to the remaining waiting time, as an hourglass proportional to the remaining waiting time and the like, is also conceivable. For this purpose, the output device may have a display device visually perceivable from outside of the rock processing apparatus, for example the aforementioned indicator instrument or a monitor with freely configurable graphical depiction or a light bar having a variable illumination dimension and the like.

Alternatively or additionally, the rock processing apparatus may have a receiving device developed separately from a machine body of the rock processing apparatus, which is movable relative to the machine body and is separable or separated from the machine body, in order to ensure that the reduction time information arrives directly where it is actually needed. The output device then outputs the reduction time information by transmitting it to the receiving device. The receiving device itself is designed to output the received reduction time information in a perceptible manner to an operator and/or to process and/or use it to control components of the machine.

In principle, the receiving device may be permanently installed in another apparatus. This is preferably the removal apparatus, particularly preferably an operator's platform of the removal apparatus. In a preferred development, the receiving device is a portable receiving device such as a smartphone, a tablet computer or a laptop computer, for example. It may then be carried along by a machine operator of the removal apparatus and thus may present the reduction time information to the machine operator even when the latter is not at his removal apparatus. Thus, a timely material reduction at the at least one stockpile may be achieved even if at the time of the output of the reduction time information, the removal apparatus is not immediately ready to remove material.

Due to the interaction between the rock processing apparatus and a removal apparatus required to ensure an operation of the rock processing apparatus at an advantageous operating point, the present disclosure also relates to a machine combination of a rock processing apparatus having a separate, separated or separable receiving device and having a removal apparatus reducing a stockpile of the rock processing apparatus in discontinuous fashion. The receiving device is preferably situated in the removal apparatus in order to provide the reduction time information where it is directly needed so as to be able to ensure a timely reduction of the at least one stockpile.

The removal apparatus may be a backhoe or a wheel loader, depending on the configuration of the job site, on which the rock processing apparatus or the machine combination is used.

The receiving device may output the reduction time information graphically and/or acoustically to a machine operator of the removal apparatus, for example also via a head-up display, so that the machine operator upon taking note of the reduction time information and possibly of the location of the stockpile to be reduced is able to perform the necessary actions to ensure a timely reduction of the stockpile. Additionally or alternatively, the receiving device may be coupled in signal-transmitting fashion to a transport-relevant operating component of the removal apparatus and control this operating component according to the reduction time information. A transport-relevant operating component may be for example at least one actuator on the removal apparatus, which moves a removal tool of the removal apparatus, such as a bucket of the backhoe or wheel loader, for filling the same.

Thus a partially automated operation assisting the machine operator of the removal apparatus or even a fully automated operation of the removal apparatus via the receiving device is possible, possibly supported by at least one further control unit on the side of the removal apparatus.

The at least one operating parameter of the rock processing apparatus, in particular material parameter and/or stockpile parameter, may be detected qualitatively and/or quantitatively. If more than one parameter is sensorially detected, then a portion of the parameters may be detected qualitatively and another portion may be detected quantitatively. Furthermore, it is also conceivable that at least one parameter is detected both quantitatively as well as qualitatively.

To determine quantities of processed and/or reduced material, the rock processing apparatus may comprise a weighing device on the processing side, which is designed to weigh processed material, and/or the removal apparatus may comprise a weighing device on the removal side, which is designed to weigh removed stockpile material.

The rock processing apparatus may be part of a rock processing system, which comprises multiple rock processing apparatuses. These multiple rock processing apparatuses preferably operate in linked fashion in the sense that a rock processing apparatus upstream in the flow of material feeds its final grain product or one of its final grain products to a material feeding apparatus of a downstream rock processing apparatus. Such a rock processing system is then also to be understood as a rock processing apparatus in the sense of the present application, which has a plurality of rock processing subapparatuses.

The type of material to be processed may be determined by one or multiple qualitative parameters and/or by one or multiple quantitative parameters. According to a classification defined in advance, a qualitative parameter may include for example “hard rock”, “soft rock”, “reinforced concrete”, “milled asphalt material”, “asphalt clod”, “demolition rubble”, “gravel”, “railroad ballast” and/or “other”.

A quantitative parameter may comprise values determined according to recognized and preferably standardized measuring methods, for example, for density and/or hardness and/or crushability and/or abrasiveness and/or moisture of the fed or conveyed material. According to a classification defined in advance, these parameters may also be determined qualitatively, in particular only qualitatively. For example, parameters may have the qualitative contents “hard”, “medium hard”, “soft”, “good crushability”, “average crushability”, “poor crushability”, “little moisture”, “average moisture”, “high moisture”, etc. The qualitative gradation may comprise more than three grades.

The density may be determined quantitatively for example from an optical volume measurement and simultaneous weighing, for example by a scale integrated in the conveyor apparatus. The moisture of the material may be ascertained by a corresponding moisture sensor. The abrasiveness may be determined by an LCPC test. The crushability of a material may be determined in parallel to the abrasiveness during the LCPC test or may be determined as a Los Angeles value in accordance with DIN EN 1097-2 in the respectively currently valid version.

### BRIEF DESCRIPTION OF THE SEVERAL VIEWS OF THE DRAWINGS

An invention is explained in greater detail below with reference to an exemplary embodiment shown in the enclosed drawings. The figures show:

FIG. 1 shows a rough schematic view of a job site with a specific embodiment of a rock processing apparatus according to the present disclosure.

FIG. 2 shows the rock processing apparatus of FIG. 1 in an enlarged schematic lateral view.

FIG. 3 shows the rock processing apparatus of FIG. 2 in an enlarged schematic top view.

FIG. 4 shows a rough schematic view of a receiving device for outputting time information.

FIG. 5 shows a rough schematic view of a receiving device for outputting location information for a material feed to a material feeding apparatus of the rock processing apparatus.

### DETAILED DESCRIPTION

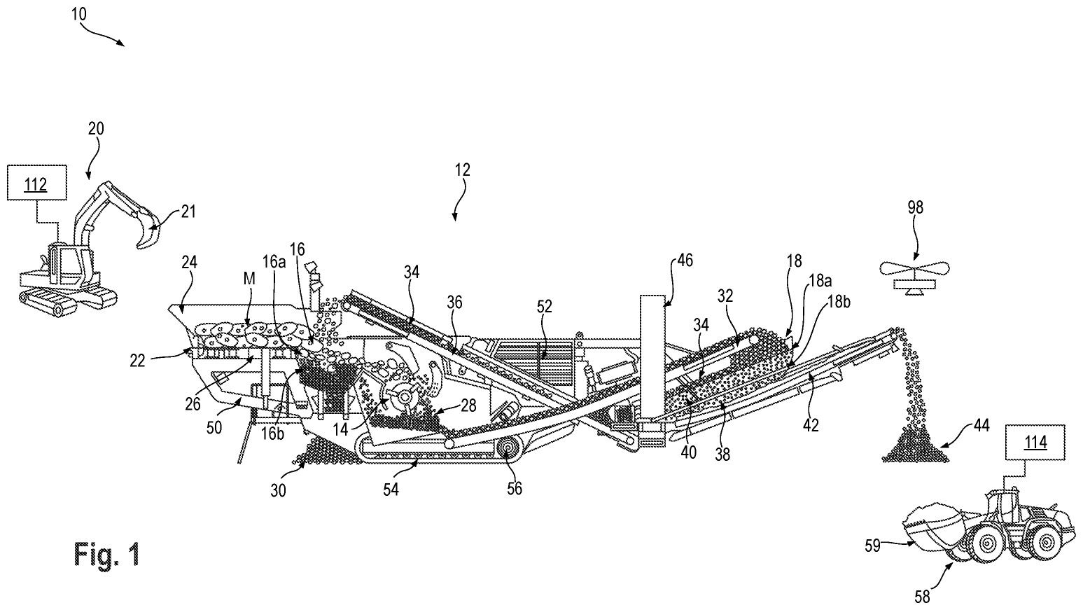

A job site is generally denoted by 10 in FIG. 1. The central implement of the job site 10 is a rock processing apparatus 12 comprising an impact crusher 14 as a crushing apparatus and a pre-screen 16 as well as a post-screen 18 as screening apparatuses. The job site is in the present case preferably a rock quarry but may also be a recycling yard or a demolition site of one or multiple buildings.

Material M to be processed by the rock processing apparatus 12, that is, to be sorted according to size and to be crushed, is fed discontinuously by being loaded by a backhoe 20 as a loading apparatus of the rock processing apparatus 12 into a material feeding apparatus 22 having a funnel-shaped material buffer 24.

From the material feeding apparatus 22, a vibrating conveyor in the form of a trough conveyor 26 conveys the material M to the pre-screen 16, which comprises two pre-screen decks 16a and 16b, of which the upper pre-screen deck 16a has a greater mesh aperture and separates and feeds to the impact crusher 14 those grain sizes that require crushing according to the respective specifications for the final grain product to be obtained.

Grains falling through the upper pre-screen deck 16a are sorted further by the lower pre-screen deck 16b into a usable grain fraction 28, which corresponds to the specifications of the final grain product to be obtained and an undersize grain fraction 30, which has a grain size that is so small that it is unusable as value grain.

The number of stockpiles or fractions shown in the exemplary embodiment is provided merely by way of example. The number may be greater or smaller than indicated in the example. Moreover, the undersize grain fraction 30 explained in the present example as waste could also be a value grain fraction if the grain size range accruing in the fraction 30 is usable for further applications.

The usable grain fraction 28 is increased by the crushed material output by the impact crusher 14 and is conveyed to the post-screen 18 by a first conveyor apparatus 32 in the form of a belt conveyor. In the illustrated exemplary embodiment, the post-screen 18 also has two screen decks or post-screen decks 18a and 18b, of which the upper post-screen deck 18a has the greater mesh aperture. The upper post-screen deck 18a allows value grain to fall through its mesh and sorts out an oversize grain fraction 34 having a grain size that is greater than the greatest desired grain size of the value grain. The oversize grain fraction 34 is returned by an oversize grain conveyor apparatus 36 into the material input of the impact crusher 14 or into the pre-screen 16. In the illustrated exemplary embodiment, the oversize grain conveyor apparatus 36 takes the form of a belt conveyor.

The useful grain of the useful grain fraction 28 thus comprises oversize grain and value grain. In contrast to the illustration in the exemplary embodiment, the oversize grain conveyor apparatus 36 may also be swiveled outward from a machine frame 50 of the rock processing apparatus 12, so that the oversize grain fraction 34 is stockpiled instead of being returned.

The value grain that fell through the meshes of the upper post-screen deck 18a is fractionated further by the lower post-screen deck 18b into a fine grain fraction 38 having a smaller grain size and a medium grain fraction 40 having a greater grain size.

Via a fine grain discharge conveyor apparatus 42 in the form of a belt conveyor, the fine grain fraction 38 is heaped to build a fine grain stockpile 44.

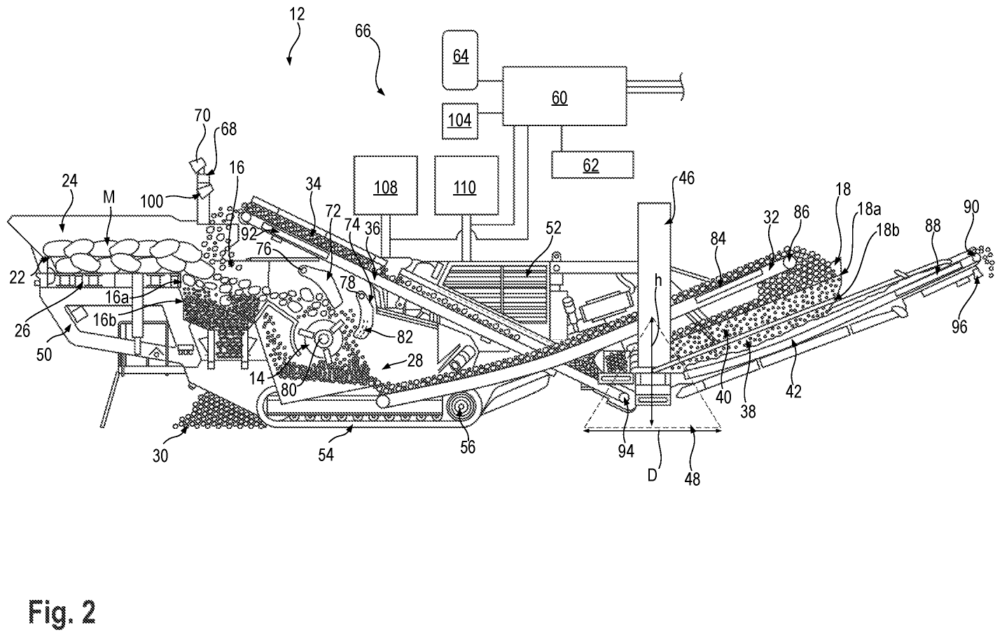

Via a medium grain discharge conveyor apparatus 46, likewise in the form of a belt conveyor, the medium grain fraction 40 is heaped to build a medium grain stockpile 48 (not shown in FIG. 1 and shown only in rough schematic fashion in FIG. 2).

As a central structure, the rock processing apparatus 12 has a machine frame 50, on which the mentioned apparatus components are fastened or supported directly or indirectly. As central power source, the rock processing apparatus 12 has a diesel combustion engine 52 supported on the machine frame 50, which generates the entire energy consumed by the rock processing apparatus 12, unless it is stored in energy stores such as batteries, for example. Additionally, the rock processing apparatus 12 may be connected to job site electrical current, if provided on the job site.

In the illustrated example, the rock processing apparatus 12, which may be part of a rock processing system having a plurality of rock processing apparatuses situated in a common flow of material, is a mobile, more precisely a self-propelled, rock processing apparatus 12 having a crawler travel gear 54, which via hydraulic motors 56 as drive of the rock processing apparatus 12 allows for a self-propelled change of location without an external towing vehicle.

A reduction of the value grain stockpiles 44 and 48 and of the stockpile of the undersize grain fraction 30 occurs discontinuously by one or several wheel loaders 58 as an example of a removal apparatus. The stockpile of the undersize grain fraction 30 must also be reduced regularly in order to ensure an uninterrupted operation of the rock processing apparatus 12.

For an operational control that is as advantageous as possible, the rock processing apparatus 12 includes, with reference to the larger illustration of FIG. 2, a control unit 60, for example in the form of an electronic data processing system with integrated circuits, which controls the operation of apparatus components. For this purpose, the control unit 60 may either control drives of apparatus components directly, for example, or may control actuators which in turn are able to move components.

The control unit 60 is connected to a data memory 62 in signal-transmitting fashion for exchanging data and is connected to an input device 64 for inputting information. Via the input device 64, for example a touchscreen, a tablet computer, a keyboard and the like, information may be input into the input device 64 and may be stored by the latter in the data memory 62.

The control unit 60 is furthermore connected in signal-transmitting fashion to an output device 66 in order to output information.

For obtaining information about its operating state, the rock processing apparatus 12 furthermore has diverse sensors, which are connected in signal-transmitting fashion to the control unit 60 and thus in the illustrated example indirectly to the data memory 62. For better clarity, the sensors are shown only in FIG. 2.

A camera 70 is situated on a supporting frame 68, which records images of the material feeding apparatus 22 with the material buffer 24 and transmits these to the control unit for image processing. With the aid of camera 70 and by processing the images it records of the material buffer 24 and of the material feeding apparatus 22, the control unit ascertains a local fill ratio of the material buffer 24 by using data relationships stored in the data memory 22.

Furthermore, a vibration amplitude and vibration frequency of the drive (not shown) of the trough conveyor 26 are detected and transmitted to the control unit 60, which ascertains from this information a conveying speed of the trough conveyor 26 and ascertains a conveying capacity of the trough conveyor 26 toward the impact crusher 14 by considering the local fill ratio of the material buffer 24.

With the aid of predetermined data relationships, generated and/or developed by methods of artificial intelligence, the control unit 60 is able to detect from image information of camera 70 a grain size distribution in the material M in the material buffer 24 and even detect the type of material.

In impact crusher 14, an upper impact wing 72 and a lower impact wing 74 are situated in a manner known per se, the rotational position of the upper impact wing 72 being detected by a rotational position sensor 76 and the rotational position of the lower impact wing 74 being detected by a rotational position sensor 78 and being transmitted to the control unit 60. Via the rotational position sensors 76 and 78, the control unit 60 is also able to ascertain a crush gap width of an upper crush gap on the upper impact wing 72 and a crush gap width of a lower crush gap on the lower impact wing 74.

A speed sensor 80 ascertains the speed of the crushing rotor of the impact crusher 14 and transmits it to the control unit 60.

On components such as blow bars, impact wings, impact plates and impact bars, for example, which are particularly subject to wear, wear sensors may be provided which register wear progress, normally in wear stages, and transmit this to the control unit 60. In the illustrated example, for better clarity, a wear sensor system 82 is shown only on the lower impact wing 74.

In the first conveyor apparatus 32, a first belt scale 84 is situated, which detects the weight or the mass of the material of the useful grain fraction 28 transported across it on the first conveyor apparatus 32. Via a speed sensor 86 in a deflection pulley of the conveyor belt of the first conveyor apparatus 32, the control unit 60 is able to ascertain a conveying speed of the first conveyor apparatus 32 and in joint consideration with the detection signals of the first belt scale 84 is able to ascertain a conveying capacity of the first conveyor apparatus 32.

A second belt scale 88 is situated in the fine grain discharge conveyor apparatus 42 and detects the mass or the weight of the fine grain of the fine grain fraction 38 moved across it on the belt of the fine grain discharge conveyor apparatus 42. In the same way, via the speed sensor 90 in a deflection pulley of the conveyor belt of the fine grain discharge conveyor apparatus 42, a conveying speed of the fine grain discharge conveyor apparatus 42 and in joint consideration with the detection signals of the second belt scale 88, a conveying capacity of the fine grain discharge conveyor apparatus 42 can be ascertained by the control unit 60.

A third belt scale 92 is situated in the oversize grain conveyor apparatus 36 and ascertains the weight or the mass of the oversize grain of the oversize grain fraction 34 conveyed across it on the oversize grain conveyor apparatus 36. A speed sensor 94 of a deflection pulley of the conveyor belt of the oversize grain conveyor apparatus 36 ascertains the conveying speed of the oversize grain conveyor apparatus 36 and transmits it to the control unit 60, which in joint consideration with the detection signals of the third belt scale 92 is able to ascertain a conveying capacity of the oversize grain conveyor apparatus.

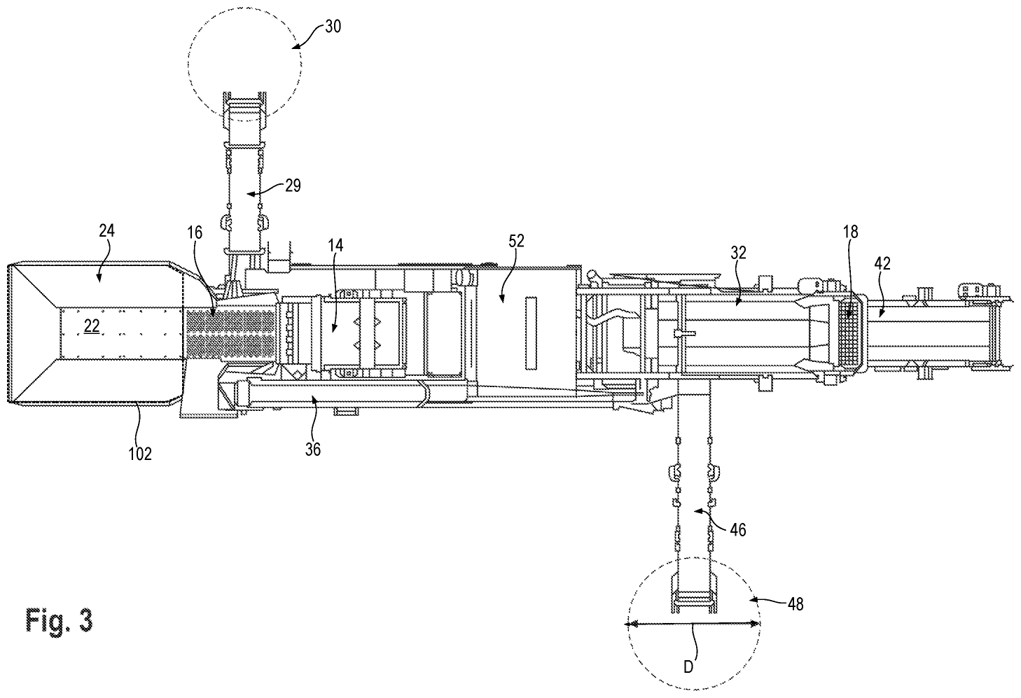

At the discharge-side longitudinal end of the fine grain discharge conveyor apparatus 42, a first stockpile sensor 96 is situated, which as a camera records images of the fine grain stockpile 44 and transmits these as image information to a control unit 60, which detects contours of the fine grain stockpile 48 by image processing and on the basis of the known image data of the camera of the first stockpile sensor 96 starting from the detected contours ascertains a shape and from that a volume of the fine grain stockpile 48. For this purpose, to simplify its information ascertainment, the control unit 60 may assume an ideal conical shape of the fine grain stockpile 48 and ascertain the volume of an ideal cone approximating the real fine grain stockpile 48 without excessive error. Thus, it may suffice if a stockpile sensor ascertains the diameter D of the base area of a stockpile and the height h of the stockpile, as is shown in FIGS. 2 and 3 in the example of stockpile 48.

FIG. 1 shows a second stockpile sensor 98 that can be used alternatively or additionally. The second stockpile sensor 98 comprises a drone capable of flying as a carrier, which may be remote controlled in its movement by control unit 60. The second stockpile sensor 98 is also used to ascertain at least a height of the fine grain stockpile 48, preferably, however, to ascertain its shape and thus its volume. An advantage of using a drone or a sensor installed at an elevated location, for example on a high mast or post, is that one sensor is able to detect more than one stockpile with respect to its height and/or its shape and/or its volume. A number of sensors that is lower than the number of stockpiles to be detected at the rock processing apparatus 12, at a rock processing system or at the job site 10 may then suffice in order to detect every one of the stockpiles to be detected. Preferably, exactly one sensor will then suffice in order to detect all of the stockpiles to be detected.

Each discharge conveyor apparatus producing a stockpile preferably has at least one stockpile sensor or cooperates with a stockpile sensor.

The other discharge conveyor apparatuses, such as the medium grain discharge apparatus 46 and an undersize grain discharge apparatus 29, preferably also have belt scale and a speed sensor for detecting the quantity of material transported on the respective conveyor apparatus, the conveying speed and hence the conveying capacity.

The output device 66 may have a projection device 100, for example on the supporting frame 68, in order to project a marker within the overall feed area 102 shown in FIG. 2, which is identical with the feed opening of the material buffer 24. The overall feed area 102 is chosen is such a way that a grain falling along the direction of the force of gravity reaches the material feeding apparatus 22 without falling directly onto the pre-screen 16.

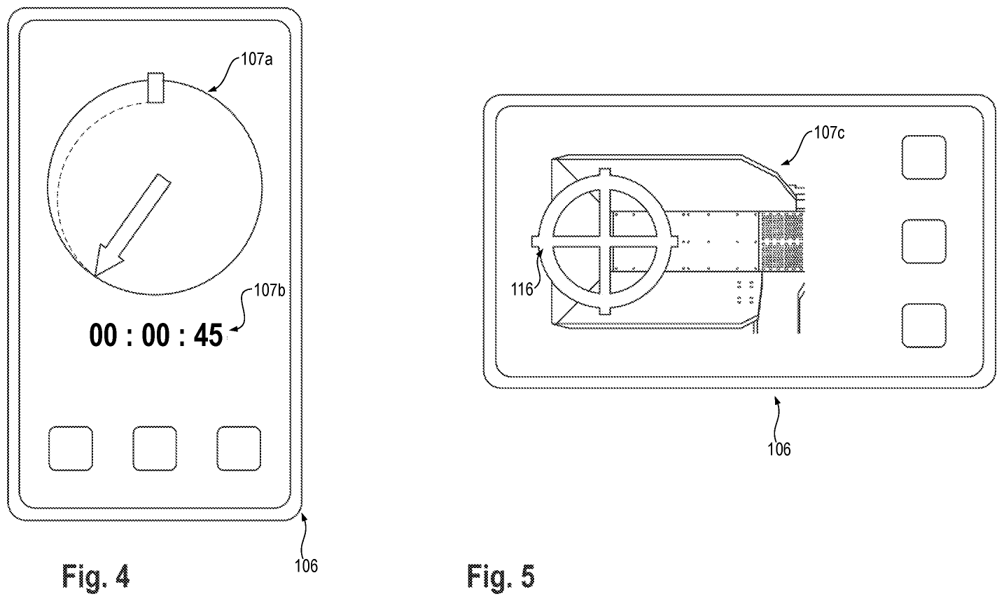

The output device 66 further comprises a transmitting/receiving unit 104, which in wireless fashion and in a suitable data protocol is able to transmit data to and receive data from a receiving device set up for communication with it, for example the receiving device 106 in FIGS. 4 and 5.

The output device 66 further includes a first display device 108, for example in the form of a monitor, for the externally perceptible display of time information about a next material feed into the material feeding apparatus 22. In the illustrated specific embodiment, the output device 66 also includes a second display device 110, for example again a monitor, for the externally perceptible display of time information and location information about a next stockpile reduction. For this purpose, the display device 110 indicates not only time information as to when a next stockpile reduction should begin, but also location information as to which of the stockpiles should be reduced at the indicated time, and possibly also by what amount the indicated stockpile should be reduced.

The backhoe 20 further comprises a transmitting/receiving device 112 including a data memory, which is set up for communication with the transmitting/receiving unit 104 of the rock processing apparatus 12. The transmitting/receiving device 112 is thus able to transmit to the transmitting/receiving unit 104 relevant data about the backhoe 20, such as the holding capacity of its bucket 21 as its loading tool and/or its current GPS data.

The wheel loader 58 accordingly comprises a transmitting/receiving device 114 including a data memory, which is set up for communication with the transmitting/receiving unit 104 of the rock processing apparatus 12. The transmitting/receiving device 112 is thus able to transmit to the transmitting/receiving unit 104 relevant data about the wheel loader 58, such as the holding capacity of its bucket 59 as its removal tool and/or its current GPS data.

In the illustrated example, the data memory 62 contains multiple data relationships, which link operating parameters and/or material parameters with one another. These data relationships may be ascertained in advance by test operations with specific parameter variations and stored in the data memory 62. In particular for more complex multidimensional data relationships, the use of methods of artificial intelligence is helpful for ascertaining causal relationships between operating parameters and/or material parameters. In the further operation of the rock processing apparatus 12, the data relationships thus ascertained may be continuously verified, refined and/or corrected, again preferably using methods of artificial intelligence.

The discontinuous material feed naturally results in a surge-like material feed, a surge of fed material being limited by the size of the bucket 21 of the backhoe 20. The time intervals between two discontinuous material feeds are not predictable and will fluctuate.

To avoid interruptions in the operational sequence of the rock processing apparatus 12, the control unit 60 ascertains on the basis of detection signals of one or multiple of the previously mentioned sensors a piece of time information, which represents an execution time of a future, in particular next, material feed into the material feeding apparatus 22.

For this purpose, the control unit 60 preferably uses the ascertained locally differentiated fill ratio of the material buffer 24 and takes into consideration the conveying capacities of the trough conveyor 26 and for example of the undersize grain conveyor apparatus 29 as well as of the first conveyor apparatus 32. An analysis of the material streams of the trough conveyor 26 into the impact crusher 14 and of the undersize grain conveyor apparatus 29 and the first conveyor apparatus 32 away from the impact crusher 14 indicates whether the fill ratio of the impact crusher 14 changes over time, for example grows or diminishes, and thus indicates whether the conveying capacity of the trough conveyor 26 can be maintained or must be changed. The conveying capacity of the trough conveyor 26, however, determines how quickly the material buffer 24 is depleted and should be loaded again with material. Alternatively or additionally, a sensor may also be provided on the rock processing apparatus 12 for detecting the fill ratio of the impact crusher 14 directly.

The control unit 60 also considers the quantity of returned oversize grain, since the oversize grain fraction 34 also contributes to the fill ratio of the material buffer 24.

A predefined data relationship stored in the data memory 62 may link the detection signals of the camera 70, of the first belt scale 84, of the speed sensor 86, of a belt scale and a speed sensor on the undersize grain discharge conveyor apparatus, of the belt scale 92 and of the speed sensor 94 of the oversize grain conveyor apparatus 36 and of the size of the bucket 21 of the backhoe 20, possibly by taking the distance of the backhoe 20 from the material feeding apparatus 22 into consideration, as input variable with a piece of time information as the output variable, which indicates when a next material feed into the material feeding apparatus 22 is to take place. This time information on the one hand may be displayed on the first output device 108 in a suitable form, for example as an hourglass, waiting time bar, time countdown or analog clock representation, perceptible for anyone within visual range of the rock processing apparatus 20.

The time information may also be transmitted by the transmitting/receiving unit 104 to a mobile receiving device 106, which is available to the machine operator of the backhoe 20. The mobile receiving device 106 may be a portable mobile device, such as a mobile telephone, a tablet computer and the like, or may be permanently installed in the backhoe as part of its control unit and may remain in the backhoe 20.

FIG. 4 shows by way of example a representation of a piece of time information on the receiving device 106 both graphically in the upper half by indicator representation 107a as well as alphanumerically in the lower half by time countdown 107b. In the illustrated case, a next material feed is desired in 00 minutes and 45 seconds.

The control unit 60 is thus able successively to control the discontinuous material feed and able to ensure a good flow of material in the rock processing apparatus 12 in spite of the discontinuity of the material feed.

Due to the local or regional resolution of the fill ratio in the material feeding apparatus 22 or in material buffer 24, the control unit 60 on the basis of a further data relationship stored in the data memory 62 is also able to control the next material feed not only in terms of time, but also spatially within the overall feed area 102 of the material buffer 24 or material feeding apparatus 22 or to indicate a piece of location information about a preferred material feed location within the overall feed area 102.

For the specific construction type of the material feeding apparatus 22 and the rock processing apparatus 12 as a whole, which may be identified parametrically in the data memory 62 so as to be usable for the control unit 60, the control unit 60 is thus able to advance the loading of the material buffer 24 in the most advantageous manner possible over the entire operating time of the rock processing apparatus 12.

Local overfilling of the material buffer 24 may thus be avoided as well as a direct feed of material onto the pre-screen 16. Furthermore, in places where locally the fill ratio within the material buffer 24 has fallen sharply, material may be fed to ensure an advantageous material bed in the material feeding apparatus 22.

On the basis of a predetermined data relationship, the control unit 60 is thus able to output location information to the machine operator of the backhoe 20 indicating where a next material feed should be provided within the overall feed area 102.

Via the projection device 100, the output device 66 is able to output this location information in a manner that is visible for everyone in that the projection device 100 within the overall feed area 102 or within the material buffer 24 projects a marker at the location at which the next material feed should take place.

Additionally or alternatively, the location information, as previously already the time information for the next material feed, may be output via the receiving device 106 to the machine operator of the backhoe 20. FIG. 5 shows an exemplary embodiment for a location information output. The receiving device 106 displays a schematic rendering 197c of the material buffer 24 with the overall feed area 102 and marks therein by a suitable marker 116 the desired feed location within the overall feed area 102 for the next material feed. Additionally, a preferred discharge height or a discharge height range may be indicated quantitatively, for example in meters and/or centimeters, or qualitatively, for example by indicating qualitative discharge height parameters such as “low”, “medium” and “high”. Particularly when communicating the location information to a, possibly partially automatic, backhoe control, the additional height information may be readily implemented.

Using the first stockpile sensor 96 and/or the second stockpile sensor 98 at the respective discharge conveyor apparatuses 29, 42 and 46, the control unit 60 is able to detect a growth of the stockpiles 30, 44 and 48 produced by the rock processing apparatus 12 by considering material parameters such as the type of the fed material, the grain size and grain size distribution and the bulk density possibly resulting therefrom, and is able above all to detect a rate of change or growth rate of the respective stockpile and, by using a previously produced and stored data relationship, to ascertain a piece of reduction time information indicating when a particular stockpile should be reduced by the wheel loader 58. This makes it possible to prevent the stockpile from growing excessively and from blocking a discharge via the discharge conveyor apparatus producing the respective stockpile.

Furthermore, by taking into consideration material parameters, such as the grain size and grain size distribution as well as the density, the control apparatus, by using a data relationship ascertained for this purpose, is able to ascertain a further piece of reduction information, which indicates to what extent a reduction is to take place.

If the rock processing apparatus 12, as in the present case, produces multiple stockpiles, then the output device 66 additionally outputs a further piece of reduction information, which identifies the stockpile to which the reduction time information pertains.

The control unit 60 is able to display the reduction time information and the further pieces of reduction information on the second display device 110 so as to be perceptible to anyone within the visual range of the rock processing apparatus 12. Additionally or alternatively, the output device 66 may transmit, via the transmitting/receiving unit 104, the pieces of information about the next stockpile reduction to the receiving device 106, where it is output to the machine operator of the wheel loader 58 in graphical and/or alphanumerical fashion.

Finally, from detection signals of suitable sensors, the control unit 60 is able to control operating parameters of the rock processing apparatus 12 in such a way that a predetermined desired ratio of fine grain quantity and medium grain quantity is obtained in the illustrated exemplary embodiment. In the same way, on the basis of appropriately prepared data relationships, the control unit 60 is able to control the rock processing apparatus 12 in such a way that its energy consumption per unit of quantity of processed mineral material reaches or is reduced to at least a local minimum. Additionally or alternatively, by using appropriately prepared data relationships, the control unit 60 is able to control the rock processing apparatus 12 in such a way that a quantity of oversize grain advantageous for the respective crushing process is returned so that a sufficient amount of support grain is present in the crush gap or in the crush gaps in the form of pre-crushed oversize grain. Indeed, an operation with the aim of minimizing or eliminating the amount of oversize grain is not necessarily the most economical operation of the rock processing apparatus 12 due to the advantageous effects of oversize grain as support grain in the crush gap. Frequently, a very small amount of oversize grain implies an excessively large amount of material that is crushed too finely, which is normally not desired. If the amount of returned material decreases, the quality of the final product often decreases along with it, since the final product then contains less repeatedly crushed material.

On the basis of the available data relationships ascertained in advance by test operations with specific parameter variation, the control unit 60 may also aim for an operation of the rock processing apparatus 12 on the basis of multiple target variables or one target variable with further specified boundary conditions, such as for example the production of value grain having different grain sizes in a predetermined quantitative proportion at lowest possible energy consumption and at the most advantageous amount of returned oversize grain.

For setting the operation of the rock processing apparatus 12 in accordance with the output variables of the at least one utilized data relationship, the control unit 60 may change the conveying speed of one or multiple conveyor apparatuses, may change the crush gap width, in particular of the upper and/or of the lower crush gap, may change the rotor speed, may control the material feed into the material feeding apparatus 22 spatially and temporally, etc.

The input variables used for optimizing the operation may be the size and/or the height and/or the growth of value grain stockpiles, presently for example the value grain stockpiles 44 and 48, the size and/or the height and/or the growth of the stockpile of the undersize grain fraction 30, the quantity of returned oversize grain, the fed grain size and fed grain size distribution, which are primarily ascertainable via the material parameters input via the input device 64. The input material parameters may comprise at least one material parameter of: the type of material, degree of humidity, hardness, density, crushability, abrasiveness, proportion of foreign substances in the fed and/or processed material, etc., the grain size and grain size distribution in the individual discharge conveyor apparatuses. The enumeration is not conclusive. In the discharge conveyor apparatuses, the grain size and grain size distribution, possibly also the grain shape, may be ascertained by cameras with subsequent image processing. The grain size and the grain size distribution in a discharge conveyor apparatus may be ascertained additionally or alternatively by the occupancy of a screening device upstream of the respective discharge conveyor apparatus in the flow of material. Additionally or alternatively, the desired setpoint quantity of a respective final product may be used as input variable for optimizing the operation.

By application of methods of artificial intelligence, the control unit 60, if desired with the involvement of powerful external data processing devices, is able continuously to improve the targeted precision of the stored data relationships by its daily operation and the data and findings gathered in the process.

The rock processing apparatus 12 itself is thus not only able to improve its own operation but is basically able successively to take over the organization of the entire job site in the vicinity of the rock processing apparatus 12.

1-15. (canceled)

16. A rock processing apparatus for crushing and/or for sorting granular mineral material according to size, the rock processing apparatus comprising:
a material feeding apparatus having a material buffer for loading starting material to be processed;
at least one working unit comprising at least one crushing apparatus and/or at least one screening apparatus;
at least one conveyor apparatus configured to convey material between apparatus components,
at least one discharge conveyor apparatus configured to convey processed material out of the rock processing apparatus onto a discontinuously reducible stockpile;
at least one stockpile sensor configured to detect at least one stockpile parameter, which represents a state and/or a change over time of a spatial size of the stockpile, and to transmit a detection signal representing the at least one detected stockpile parameter;
a control unit configured
to ascertain, in an operation with a discontinuous reduction of the at least one stockpile, reduction time information based on the at least one detection signal, which represents an execution time of a future reduction of the stockpile by removing material from the stockpile, and
to control apparatus components of the rock processing apparatus;
at least one output device connected to the control unit and configured to transmit output information comprising the ascertained reduction time information.

17. The rock processing apparatus of claim 16, wherein:
the at least one stockpile sensor is configured to detect at least one shape dimension of the stockpile as the at least one stockpile parameter, and
the control unit is configured to ascertain, based on the at least one detected shape dimension, a height of a stockpile top and/or a change over time of the height of the stockpile top of the stockpile as a growth parameter of the stockpile.

18. The rock processing apparatus of claim 16, wherein the at least one stockpile sensor is configured to detect a height of a stockpile top as the at least one stockpile parameter and/or a change over time of the height of the stockpile top of the stockpile as the at least one stockpile parameter and thus as a growth parameter of the stockpile.

19. The rock processing apparatus of claim 18, wherein the control unit is configured to ascertain, from at least two detections of the at least one stockpile parameter, which occurred with a time interval, and the time interval between the at least two detections, at least one growth parameter of the stockpile.

20. The rock processing apparatus of claim 17, wherein the control unit is configured to retrieve a lower height threshold value of the stockpile from a data memory and to ascertain, starting from the growth parameter, reduction time information for an earliest future reduction of the stockpile.

21. The rock processing apparatus of claim 17, wherein the control unit is configured to retrieve an upper height threshold value of the stockpile from a data memory and to ascertain, starting from the growth parameter, reduction time information for a latest future reduction of the stockpile.

22. The rock processing apparatus of claim 16, comprising an input device connected to the control unit, wherein the control unit is configured, in the operation with a discontinuous stockpile reduction, to ascertain the reduction time information based on the at least one detection signal and information input into the input device.

23. The rock processing apparatus of claim 16, wherein the at least one stockpile sensor is situated as an apparatus-supported stockpile sensor on the rock processing apparatus, which heaps the stockpile detected by the stockpile sensor.

24. The rock processing apparatus of claim 23, wherein the at least one stockpile sensor is situated as an apparatus-supported stockpile sensor on the discharge conveyor apparatus.

25. The rock processing apparatus of claim 16, wherein the at least one stockpile sensor is secured in position in surroundings of the rock processing apparatus as a stationary, ground-supported stockpile sensor at a spatial distance from the rock processing apparatus, but connected to the rock processing apparatus in signal-transmitting fashion.

26. The rock processing apparatus of claim 16, wherein the at least one stockpile sensor is provided as a mobile stockpile sensor movable relative to the rock processing apparatus, but connected to the rock processing apparatus in signal-transmitting fashion.

27. The rock processing apparatus of claim 16, wherein the at least one stockpile sensor is configured to detect the at least one stockpile parameter acoustically and/or by electromagnetic radiation and/or in a tactile manner.

28. The rock processing apparatus of claim 16, wherein the output device is configured to output, in addition to the reduction time information, information about a type and/or composition and/or location of the stockpile material.

29. The rock processing apparatus of claim 16, wherein the output device is configured to output information independently of a receiver in a spatial area surrounding the rock processing apparatus at least partially and/or adjoining the rock processing apparatus.

30. The rock processing apparatus of claim 16, comprising a receiving device developed separately of a machine body of the rock processing apparatus and movable relative to the machine body and separable or separated from the machine body, wherein the output device is configured to transmit output information comprising the reduction time information to the receiving device.

31. The rock processing apparatus of claim 30, wherein the receiving device is a portable receiving device.

32. A machine combination comprising:
a rock processing apparatus comprising
a material feeding apparatus having a material buffer for loading starting material to be processed,
at least one working unit comprising at least one crushing apparatus and/or at least one screening apparatus,
at least one conveyor apparatus configured to convey material between apparatus components,
at least one discharge conveyor apparatus configured to convey processed material out of the rock processing apparatus onto a discontinuously reducible stockpile,
at least one stockpile sensor configured to detect at least one stockpile parameter, which represents a state and/or a change over time of a spatial size of the stockpile, and to transmit a detection signal representing the at least one detected stockpile parameter,
a control unit configured
to ascertain, in an operation with a discontinuous reduction of the at least one stockpile, reduction time information based on the at least one detection signal, which represents an execution time of a future reduction of the stockpile by removing material from the stockpile, and
to control apparatus components of the rock processing apparatus,
at least one output device connected to the control unit and configured to transmit output information comprising the ascertained reduction time information; and
a removal apparatus provided for the discontinuous stockpile reduction, and having situated thereon a receiving device,
wherein the output device is configured to transmit output information comprising the reduction time information to the receiving device.

33. The machine combination of claim 32, wherein the receiving device is configured to output the reduction time information graphically and/or acoustically to a display device of the removal apparatus.

34. The machine combination of claim 32, wherein the receiving device is configured to control a transport-relevant operating component of the removal apparatus.

35. The machine combination of claim 32, wherein the rock processing apparatus comprises:
a weighing device on the processing side, configured to weigh processed material; and/or
a weighing device on the removal side, configured to weigh removed stockpile material.
